(19) United States
(12) Patent Application Publication
(10) Pub. No.: US 2002/0068157 A1
(43) Pub. Date: Jun. 6, 2002

(54) Products with biofunctional coating

(75) Inventor: Erik Wischerhoff, Bunnik (NL)

Correspondence Address: Ronald J. Baron, Esq., HOFFMAN & BARON, LLP, 6900 Jericho Turnpike, Syosset, NY, 11791, US

(73) Assignee: Glaucus Proteomics B.V.

(21) Appl. No.: 09/994,473

(22) Filed: Nov. 26, 2001

Related U.S. Application Data
(63) Continuation of application No. PCT/NL01/00776, filed on Oct. 24, 2001.

(30) Foreign Application Priority Data
Oct. 26, 2000 (EP) 00203767.9

(51) Int. Cl. B65B 1/00; B65C 1/00; B31B 1/60; B32B 31/00; B32B 7/02

(52) U.S. Cl. 428/212; 156/60

(57) ABSTRACT

The invention relates to products comprising a solid surface, a multilayer system of at least two covalently interconnected layers of a polymeric material covalently attached to said surface, and a biofunctional layer covalently attached to said multilayer system. The biofunctional layer may comprise a bioactive ingredient to make the product useful for numerous applications, such as biosensors, implants, sample containers, affinity sensor arrays and affinity chromatography media.

The invention also relates to methods for making such products.

The use of a multilayer system of organic polymers allows to obtain almost identical biofunctional surfaces on very different substrates and provides a more complete shielding of the original surface of the substrate which reduces non-specific adsorption of biomolecules.

### FIELD OF THE INVENTION

The invention relates to products carrying a biofunctional coating, more particularly, products having a solid surface with a biocompatible or other kind of biofunctional coating thereon.

More specifically, the invention provides products comprising a multilayer system of polymeric materials and a biofunctional layer on a solid surface thereof, and methods for preparing such coated products.

### BACKGROUND OF THE INVENTION

Surfaces for affinity chromatography, affinity biosensing, solid phase diagnostics, high performance sample containers, implants, solid phase bio-organic synthesis, extra-corporeal therapy and others all have one important requirement in common: the surface must inhibit non-specific adsorption. In view thereof, they need specific surface properties to fulfill their task. Often this is achieved by a chemical surface modification. A technical solution for this problem could in principle be applied to all types of surfaces of interest, given that the surface chemistry involved is generally applicable and flexible enough to allow for the introduction of additional specific features which are desirable for individual applications. For example, for an affinity biosensor, even more requirements exist: it must provide the desired specificity, sensitivity and reproducibility. This implies that the sensor surface must offer appropriate coupling sites for biomolecules providing the specificity while concomitantly suppressing non-specific adsorption of components from various analyte solutions. Furthermore, the sensor surface must offer all these features reproducibly, i.e. the variation of properties among different sensors must not exceed reasonable limits, therefore irregularities introduced by the chemical modification of the original surface must be eliminated most effectively, an issue which is also important for the other possible applications.

Most of the solutions for biocompatible coatings existing to date are limited to one specific application, because the surface chemistries involved are not generally applicable. For example, in the case of affinity biosensors, there are many different approaches to the problem, each of them is restricted to one kind of surface and is afflicted with specific disadvantages.

In early examples, biomolecules providing the specificity of an affinity biosensor were crudely adsorbed onto the surface, a primitive but in some cases effective method which is still used nowadays e.g. in enzyme linked immunosorbent assays (ELISAs). Concerning stability, specificity and reproducibility, this method has serious shortcomings. Therefore, fixation of biomolecules via flat monolayers consisting of low molar mass linker molecules was attempted. (The phrase ‘low molar mass linker molecules’ as used herein refers to linker molecules that are not composed of repeat units, to distinguish from polymeric substances.) In many cases, this method of immobilization provides satisfactory results, but often, high performance affinity biosensors make use of the unique properties of surface-bound hydrogels, which provide a three-dimensional (3D) biocompatible matrix, to improve the performance of the sensor surface.

Hydrogel materials resemble, in their physical properties, living tissue more than any other class of synthetic material. In particular, their relatively high water contents and their soft, rubbery consistency give them a certain degree of resemblance to living soft tissue. This consistency can contribute to their biocompatibility by minimizing friction.

The most intriguing of the potential advantages for hydrogels is the low interfacial tension that may be exhibited between a hydrogel surface and an aqueous solution. This low interfacial tension should reduce the tendency of the proteins or other biomolecules in analyte solutions or body fluids to adsorb and to unfold upon adsorption.

A crucial aspect for the performance of both molecularly flat and hydrogel sensor surfaces is the completeness and reproducibility of surface coverage. An investigation on dextran hydrogels covalently coupled to silica surfaces (Schacht et al., Molecular Resolution Imaging of Dextran Monolayers Immobilized on Silica by Atomic Force Microscopy, Langmuir 12 (1996) pp. 6436-6442) demonstrates the problem of homogeneous surface coverage at a microscopic scale. Several successful approaches to overcome this problem were made in the past, but they are only related to noble metal surfaces. In EP-A-0 589 867, a sensing surface is disclosed, which comprises a self-assembled monolayer (SAM) composed of compounds with alkyl chains having 10 or more carbon atoms. These SAMs are densely packed because of the chain crystallization occurring among the alkyl chains and thus, the efficient segregation of the sensing or hydrogel layer from the original metal surface ensures good biosensor performance. Though being efficient, this specific solution for a biosensor surface has some disadvantages. The method is only effective for noble metal surfaces. Moreover, at least in some of the preferred examples for its use, toxic and carcinogenic chemicals have to be employed. In addition, the synthesis of some of the compounds needed is lengthy.

Therefore, other approaches were made. In DE-A-198 17 180 A1, a biosensor with a modified noble metal surface is described. Here, in order to obtain an efficient separation of the sensing hydrogel layer from the original surface and thus a homogeneous coating, short-chained monomolecular interlayers exhibiting secondary valence interactions or metal oxide interlayers are employed. The approaches disclosed in DE- A-198 17 180 A1 are not applicable to a broad variety of materials, but are mainly restricted to metals reacting with thiols, disulfides or chemically similar compounds, and, moreover, those solutions relying on molecular interactions in a monolayer can only be efficient for surfaces with a roughness not exceeding a few nanometers. Furthermore, the specific solution relying on metal oxide layers is inherently prone to deterioration under harsh basic conditions, which implies restrictions in the use.

### SUMMARY OF THE INVENTION

An objective of the present invention is to provide a product having a biofunctional coating with improved performance providing a molecularly flat surface or a 3D matrix, ensuring efficient reduction of non-specific adsorption and optionally providing the possibility of immobilization of biomolecules avoiding denaturation.

Surprisingly it was found that by using a multilayer system of at least two covalently interconnected layers of polymeric materials, in particular organic polymers, the objective can be met and the above mentioned problems of the prior art can, at least in part, be overcome.

As an outstanding characteristic of this biofunctional and usually biocompatible coating, it can be produced on virtually any surface. The biofunctional coating according to the invention may be applied to a structure composed of a solid substrate, which substrate may be practically of any shape, e.g. flat, round, or irregularly shaped, and may be constructed from any of a large variety of materials (e.g. an inorganic material like glass, quartz, silica, but also other materials like noble metals, semiconductors, e.g. doped silicon, metal oxides, and plastics, e.g. polystyrene or polypropylene, are possible). In order to prepare the surface of an object for a certain coating, it has to be treated in a suitable primary functionalization step, depending on the type of surface and on the type of coating. This primary functionalization step may comprise e.g. chemisorption of low molar mass compounds (i.e. non-polymeric compounds) or polymers. Other possibilities for the primary functionalization step are chemical or plasma etching.

The multilayer structure of the invention is composed of at least two, preferably three to six or more, covalently attached layers of polymeric materials, in particular organic polymers, preferably polyamines and polycarboxylates, and an additional covalently attached polymer or low molar mass layer (also referred to as a “biofunctional layer” herein) which is suitable for the covalent attachment of biomolecules, preferably a hydrogel with functional groups, preferably carboxymethyl dextran.

One of the distinct advantages of the present invention is that a large variety of polymer combinations may be used for the coating according to the invention.

### BRIEF DESCRIPTION OF THE DRAWINGS

FIG. 1: Resonance curves of multilayer assembly 1 described in example 1 obtained by surface plasmon resonance measurements. The graph shows the reflected light intensities expressed in photodiode voltage as a function of the angle of incidence expressed in arbitrary units. All polymer deposition steps result in the deposition of about the same amount of material.

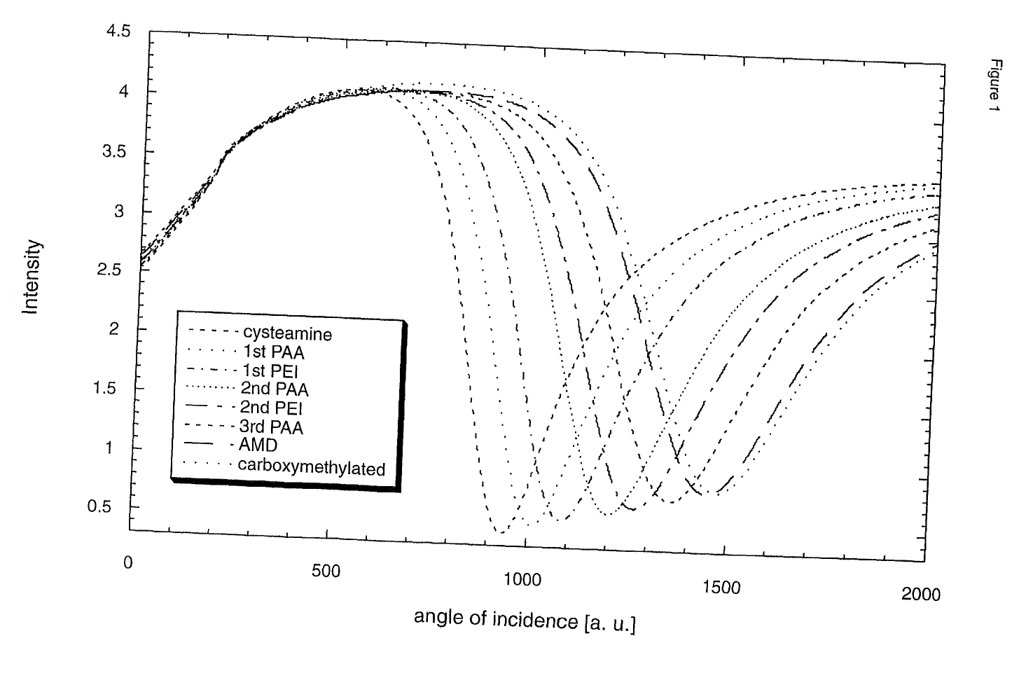

FIG. 2: Resonance curves of multilayer assembly 2 described in example 2 obtained by surface plasmon resonance measurements. The graph shows the reflected light intensities expressed in photodiode voltage as a function of the angle of incidence expressed in arbitrary units. The first few depositions of polymer result in the deposition of little material, but with increasing number of steps, the amount of deposited material per step becomes comparable to the results for assembly 1.

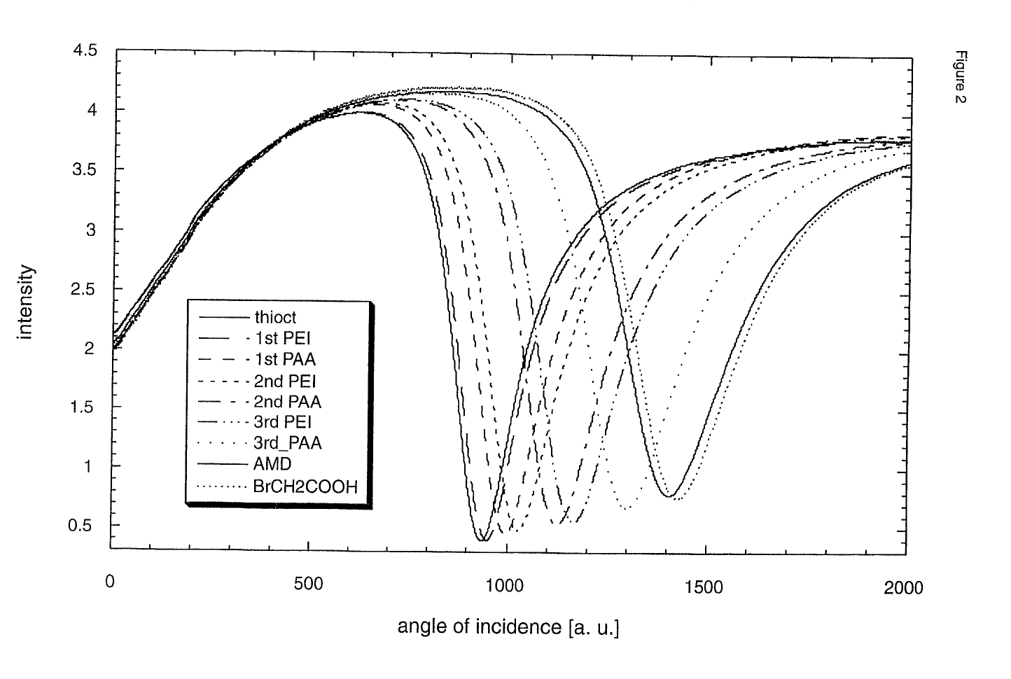

FIG. 3: Detail of FIG. 1. Only the resonance curves taken after the first three deposition steps of assembly 1 are shown.

FIG. 4: Detail of FIG. 2. Only the resonance curves taken after the first three deposition steps of assembly 2 are shown.

FIG. 5: Detail of FIG. 1. Only the resonance curves taken after the last polymer and the hydrogel deposition step of assembly 1 are shown.

FIG. 6: Detail of FIG. 2. Only the resonance curves taken after the last polymer and the hydrogel deposition step of assembly 2 are shown.

FIG. 7a: Plot of the resonance angle (=angle of minimal reflected light intensity) as a function of time after incubation of assembly 1 in a solution of biotinylated protein A. The change in resonance angle is caused by the binding of biotinylated protein A to streptavidin covalently immobilised on assembly 1.

FIG. 7b: Plot of the resonance angle (=angle of minimal reflected light intensity) as a function of time after incubation of assembly 2 in a solution of biotinylated protein A. The change in resonance angle is caused by the binding of biotinylated protein A to streptavidin covalently immobilised on assembly 2.

FIG. 8: Plot of the resonance angle (=angle of minimal reflected light intensity) as a function of time after incubation of assembly 2 in a solution of bovine serum albumine (BSA). The change in resonance angle is only caused by the higher refractive index of the BSA solution compared to buffer. After the BSA solution is exchanged by buffer, the signal goes back to the original level, indicating that only negligible non-specific binding has taken place.

FIG. 9: Resonance curves of assembly 2 before and after BSA exposure.

FIG. 10: Surface plasmon resonance curves of multilayer assembly described in example 3, measured for different layers measured after their deposition.

FIG. 11: Interaction experiments on a multilayer modified surface with a hydrogel containing covalently immobilised protein A as top layer, as described in example 3.

### DETAILED DESCRIPTION OF THE INVENTION

In one aspect, the present invention provides a product comprising a solid surface, a multilayer system of at least two covalently interconnected layers of a polymeric material covalently attached to said surface, and a biofunctional layer covalently attached to said multilayer system.

Herein, the term “biofunctional” refers to a functional property with respect to biological molecules or systems, such as compatibility with certain biological molecules, systems or surroundings, specific binding properties vis-à-vis certain biological molecules or systems, specific reactivities with certain biological molecules or systems, etc.

The term “polymeric material” covers both organic and inorganic polymeric materials, in particular organic polymers and inorganic colloids, such as gold colloids. (Gold colloids are microscopic particles consisting of gold atoms chemically bound to each other in the same manner as in bulk gold. Their typical size is about 2-50 nm, and as a result they do not scatter visible light when dispersed.)

The term “multilayer system” intends to refer to a sequence of at least two layers, which are well defined, coherent and dense layers covalently interconnected at multiple sites and together cover up possible defects and thereby help to effectively prevent non-specific adsorption.

A product with the biofunctional coating of the present invention has a number of advantages compared to systems known from the state of the art.

The multilayer assembly of the present invention compensates for the differences occurring between different substrates, mostly differences in the density of functional groups on the original surface, caused by the specific properties of the material and/or the specific primary functionalization step or differences in the surface morphology that have a direct influence on the properties of layers attached to the substrate. The invention therefore allows to produce the same or almost the same biofunctional (optionally biocompatible) surface on different substrates, even substrates made of completely different materials.

Further, the present invention achieves a more complete shielding of the original surface compared to the state of the art. One desirable result is that non-specific adsorption is prevented more completely. Moreover, the attachment of biomolecules to different surfaces covered with a multilayer assembly according to the invention provides very similar results, for example with respect to surface biochemistries.

The physical properties of the product (e.g. refractive index, thickness, mechanical properties, optical transparency) may be easily fine-tuned by choosing the number of the polymeric layers and their chemical composition, therefore the approach is extremely versatile.

Furthermore, in contrast to multilayer assemblies made by alternate polyion adsorption (see e.g. G. Decher, J. D. Hong, Buildup of Ultrathin Multilayer Films by a Self-Assembly Process: II. Consecutive Adsorption of Anionic and Cationic Bipolar Amphiphiles and Polyelectrolytes on Charged Surfaces, Ber. Bunsenges. Phys. Chem. 95 (1991) pp.1430-1434), covalently coupled layers, which can be obtained according to the present invention, are resistant to high salt concentrations.

Although self assembled monolayers with long alkyl chains as described in EP-A-0 589 867 are less prone to defects than systems with shorter chains, there is still a danger of imperfect surface coverage. A multilayer system composed of polymeric layers minimizes the chance of defects more effectively, since any pinhole-like defect in one of the layers is more likely to be bridged by the next polymer layer on top of it.

Compared to the metal oxide interlayers described in DE 198 17 180 A1, covalently attached multilayer systems are more resistant to harsh basic conditions, thus widening the range of applications for the biofunctional surface.

Compared to dextran layers described in Schacht et al., mentioned hereinabove, the surface coverage of a biofunctional coating with a hydrogel layer prepared according to the present invention is superior.

In the product of the invention, the multilayer system is attached to the solid surface preferably via low molar mass linker molecules. Herein, the phrase “low molar mass” means non-polymeric, i.e. not composed of repeat units.

In the product of the invention, the biofunctional layer may further comprise a bioactive ingredient. Examples of bioactive ingredients, the choice of which depends on the type of product concerned, are: antibodies, enzymes or other kinds of proteins, including antigens, haptens and allergens; peptides (oligopeptides or polypeptides), hormones, avidin and related proteins like neutravidin and streptavidin, nucleic acid molecules, i.e. DNA or RNA molecules, including cDNA, oligo- and polynucleotides, PNA, low molecular mass compounds such as biotin, drugs or pharmacons, toxins, steroids, and derivatives thereof, etc. In principle, any biomolecule can be attached to the surfaces in question.

In the product of the invention, the solid surface can be almost any material, but will normally be selected from the group consisting of a metal, a metal oxide, a semiconductor, a semimetal oxide, a transitional element oxide, glass, silica, a plastic, and combinations thereof Preferably, the solid surface is selected from the group consisting of a noble metal, glass, silica, a plastic, and combinations thereof.

The covalently interconnected layers of the multilayer system of the invention preferably consist of organic polymers, or an organic polymer and a colloid.

The multilayer system of the invention may comprise covalently linked alternating layers of a first and a second polymer, which first and second polymer comprise functional moieties, which functional moieties are a pair selected from carboxylate/amine, sulfate/amine, sulfonate/amine, alcohol/epoxide, amine/carbonate residues, and thiol/disulfide; for the moieties on the first polymer/second polymer respectively. Preferably, the first polymer is chosen from the group consisting of poly(acrylic acid), poly(methacrylic acid), poly-(styrene-4-carboxylic acid) and poly(glutamic acid), while the said second polymer is chosen from the group consisting of poly(ethylenimine), poly(allylamine), poly-(lysine) and poly(arginine). In an alternative embodiment, the multilayer system comprises covalently linked alternating layers of a polymer with thiol groups and a metal colloid, in particular an Au colloid.

When thiol/disulfide is used, “regeneration” of the surface can be carried out, viz. cleavage of the polymer layers by reduction, e.g. reduction with sodium dithionite.

The thiol/Au colloid chemistry provides a surface with built-in detector. Au colloids absorb visible light and they are sensitive to changes in the refractive index in close proximity, as a result of which the wavelength of maximum absorbance shifts on change of local refractive index.

In a particularly preferred embodiment, the first and the second polymer are a poly(active ester)/poly(amine) respectively. This provides for a short reaction time and low reagent concentrations.

Another preferred combination is poly(epoxide)/poly(alcohol). This embodiment does not require additional activation agents.

The product of the invention comprises at least two covalently interconnected polymer layers, but preferably comprises from 3 to 6 covalently interconnected polymer layers.

The thickness of the individual polymer layers preferably does not exceed 20 nm, and even more preferably does not exceed 10 nm. Normally, the layers are monolayers, i.e. the thickness of the individual layers is in the same order of magnitude as the size of the monomers from which the polymers are composed. The diameter of colloid particles preferably does not exceed 30 nm.

The biofunctional layer may comprise low molar mass molecules that are covalently coupled to the outermost polymer layer. In a much preferred embodiment, the biofunctional layer comprises a hydrogel, most preferably a hydrogel that bears biofunctional groups. The hydrogel may comprise a synthetic hydrophilic polymer, preferably one selected from the group of poly(vinylalcohol), poly(hydroxyethylacrylate), poly(hydroxyethyl-methacrylate), poly[tris(hydroxymethyl)methylacrylamide], poly(ethylene oxide), poly(1-vinyl-2-pyrrolidon) and poly(dimethylacrylamide), or copolymers thereof. Most preferably, the biofunctional layer is a hydrogel comprising a polysaccharide, especially a polysaccharide selected from the group of dextran, pullulan, inulin and hydroxyethylcellulose. The hydrogel preferably bears biofunctional groups that are carboxy groups and/or amino groups.

The present invention provides the further advantage that the coating has a polymeric nature, which will strongly reduce leaching from the surface. E.g., a surface prepared according to the invention having a hydrogel top layer provides some important features for implants wherein a minimal protein interaction is important for the biological rejection mechanisms. The avoidance of leaching of residual low molar mass compounds from the surface coating prevents inflammation and rejection and the soft consistency minimises mechanical irritation to surrounding cells and tissue. The in vivo leaching of low molecular mass compounds from an implant surface may result in inflammation and rejection of implants.

Another interesting application of the coatings of the present invention, particularly when the coating further comprises a hydrogel, is for affinity chromatography media. In this case, solid phases carrying immobilized biomolecules can be made. Also sample containers can be made in this way, the main purpose being the prevention of non-specific absorption. This may be useful, for example, when analyzing complex protein mixtures, containing low abundance proteins, especially in small volumes with a high surface to volume ratio, non-specific adsorption of these compounds to the container wall would severely falsify the experimental results. This undesirable effect can be avoided with a hydrogel coating prepared according to the invention.

As already mentioned, the objects to which the coating is applied may be virtually any shape, such as flat, round, or irregularly shaped.

The product according to this invention is preferably selected from the group consisting of biosensors, implants, sample containers, affinity sensor arrays, affinity chromatography media, devices for solid phase diagnostics, devices for solid phase bio-organic synthesis, devices for extra-corporeal therapy, and others. Apart from the use as implants, the coated objects of the invention find use in different fields of application. One such field is affinity biosensors, e.g. biosensors based on surface plasmon resonance (SPR), waveguides, resonant mirrors, quartz crystal microbalances, reflectometric interference spectroscopy (RIfS) and other interferometric methods, surface acoustic waves, affinity sensor arrays, based on one of the physical readout mechanisms mentioned above or based on fluorescence or chemiluminescence. Another type of application is in sample containers, e.g. vials or microtitre plates, or in affinity chromatography media, e.g. silica particles or polystyrene beads. A further possible application is in devices for extracorporeal therapy in which for example blood from a patient is circulated outside the body along the surface of a product of the invention which contacts the blood with a selected biologically active substance. Products of the invention can also be used in a device for bio-organic synthesis, in which the surface of the product carries a specific enzyme that is involved in the synthesis for exposure to the reactants.

A preferred form of a microtitre plate is made of a plastic substrate on which the multilayer is present, preferably having a hydrogel top layer without biofunctional groups.

For use in SPR biosensors, the multilayer system may be applied to a gold carrier, and preferably has a hydrogel top layer with carboxymethyl groups.

A sensor array on glass preferably may comprise a hydrogel layer as outermost layer with carboxymethyl groups, and a hydrogel without biofunctional groups as a spacing between the sensor subunits.

The coated products of the present invention may be prepared by various methods, preferably however by a method for making a product having a solid surface coated with polymer layers and a biofunctional layer, comprising the steps of

(a) functionalizing said surface (i.e. generating functional groups, using an appropriate method depending on the nature of the surface);

(b) covalently coupling a polymer layer with one type of functional group to said surface;

(c) covalently coupling a polymer layer with a second type of functional groups to the previous polymer layer, optionally after having activated the functional groups of said previous polymer layer with a suitable activating reagent;

(d) optionally repeating steps (b) and (c); and

(e) covalently coupling a biofunctional layer, which may be composed of low molar mass compounds or polymers and is suitable for the binding of bioactive molecules and/or the prevention of non-specific adsorption, to the assembly.

The formation of covalently attached multilayer systems according to the invention will now be further illustrated with reference to the Reaction Schemes 1-4.

Scheme 1 shows the covalent attachment of a polyamine to a substrate such as glass comprising epoxy groups. This multilayer may be prepared by the following steps.

(1) covalent attachment of polyamine, e.g. poly(allylamine) on glass treated with 3-(glycidyloxypropyl)triethoxysilane;

(2) in situ generation of carboxylate/NHS ester copolymer, e.g. poly[(acrylic acid)-co-(N-hydroxysuccinimidyl acrylate)], reaction with amine;

(3) Ethyl-3-(dimethylamino)propyl-carbodiimide (EDC)/N-hydroxysuccinimide (NHS);

(4) polyamine, s. a.;

(5) repeat steps (2) to (4);

(6) carboxymethyl polysaccharide, e.g. carboxymethyl dextran.

Scheme 2 illustrates an embodiment in which the outer layer comprises a dextran derivate. It can be prepared by the following steps.

(1) epoxy surface, e.g. glass treated with 3-(glycidyloxypropyl)-triethoxysilane;

(2) polyamine, e.g. poly(ethyleneimine);

(3) poly(glycidyl acrylate);

(4) repeat steps (2) and (3);

(5) polyalcohol or copolymer with OH groups, e.g. carboxy methyl dextran.

Scheme 3 illustrates the formation of a multilayer involving gold colloids. It can be prepared by carrying out the following steps.

(1) Au surface;

(2) polymer with thio groups;

(3) Au colloids;

(4) repeat steps (2) and (3);

(5) copolymer with amino and thio groups;

(6) carboxymethyl polysaccharide, EDC/NHS.

Scheme 4 shows the formation of a multilayer on a plastic substrate using diazirine compounds. It can be prepared by carrying out the following steps.

(1) plastics surface;

(2) adsorption of copolymer with aryl diazirine groups and sulfonate groups;

(3) irradiation resulting in the formation of covalent bonds between substrate and the copolymer of step (2);

(4) EDC, NHS;

(5) polyamine;

(6) polymer with sulfonate groups, EDC/NHS;

(7) polyamine;

(8) optionally repeat (6) and (7);

(9) carboxymethyl polysaccharide, EDC/NHS.

The invention will now be further illustrated with the following Experimental Section.

### EXAMPLES 1-2

General Remarks:

SPR measurements were performed with a home-built Θ/2Θ-setup according to Kretschmann and Raether (E. Kretschmann, H. Raether, Radiative Decay of Non-Radiative Surface Plasmons Excited by Light, Z. Naturforsch., vol. 23a, p. 2135 (1968));

concentrations of the polymers always refer to the repeat units;

H₂O is demineralised H₂O with a minimum resistivity of 5 MΩ;

in order to enable monitoring of the multilayer assembly by SPR, the gold surfaces are approx. 50 nm thick gold layers on a glass prism.

Comparison of two different multilayer assemblies on gold by surface plasmon resonance (SPR) measurements:

Experimental Conditions Assembly 1:

(1) cleaning of gold surface by immersion in 0.1M KOH/30 wt % H₂O₂ (50:50 vol.) for 20 minutes at 60° C.;

(2) preparation of a solution of cysteamine (2·10⁻² mol·1⁻¹) in water;

(3) immersion of cleaned gold surface in cysteamine solution for 20 h at ambient temperature;

(4) rinsing in water for 1 minute;

(5) incubation in a polyacrylic acid solution (5·10⁻² mol·1⁻¹) in DMSO/water (60:40 vol.) with 19 mg of EDC and 11.5 mg of NHS per ml for 30 minutes;

(6) rinsing with water for 1 minute;

(7) incubation in an aqueous polyethyleneimine solution (5·10⁻² mol·1⁻¹) for 30 minutes;

(8) rinsing with water for 1 minute;

(9) repeat 5 to 8 one time;

(10) incubation in a polyacrylic acid solution (5·10⁻² mol·1⁻¹) in DMSO/water (60:40 vol.) with 19 mg of EDC and 11.5 mg of NHS per ml for 30 minutes;

(11) incubation in an aqueous 10 wt % solution of aminodextran (prepared according to J. Piehler, A. Brecht, K. E. Geckeler, G. Gauglitz; Surface modification for direct immunoprobes, Biosensors & Bioelectronics 11, 579-590 (1996)) for 30 min;

(12) rinsing with water three times for 1 minute;

(13) incubation with 1 mol·1⁻¹ bromoacetic acid in 2 M NaOH for 12 h;

(14) rinsing with water three times for 1 minute.

Experimental Conditions Assembly 2:

(1) cleaning of gold surface by immersion in 0.1M KOH/30 wt % H₂O₂ (50:50 vol.) for 20 minutes at 60° C.;

(2) preparation of a solution of thioctic acid (2·10⁻² mol·1⁻¹) in water;

(3) immersion of cleaned gold surface in thioctic acid solution for 20 h at ambient temperature;

(4) rinsing in water for 1 minute;

(5) incubation in an aqueous polyethyleneimine solution (5·10⁻² mol·1⁻¹) for 30 minutes;

(6) rinsing with water for 1 minute;

(7) incubation in a polyacrylic acid solution (5·10⁻² mol·1⁻¹) in DMSO/water (60:40 vol.) with 19 mg of EDC and 11.5 mg of NHS per ml for 30 minutes;

(8) rinsing with water for 1 minute;

(9) repeat 5 to 8 two times;

(10) incubation in an aqueous 10 wt % solution of aminodextran (prepared according to J. Piehler, A. Brecht, K. E. Geckeler, G. Gauglitz; Surface modification for direct immunoprobes, Biosensors & Bioelectronics 11, 579-590 (1996)) for 30 min;

(11) rinsing with water three times for 1 minute;

(12) incubation with 1 mol·1⁻¹ bromoacetic acid in 2 M NaOH for 12 h;

(13) rinsing with water three times for 1 minute.

In the SPR measurements, the shifts in the minimum of the resonance curve (the resonance angle) reflect a change of the local refractive index at the interface. Therefore, the shifts correspond either to a change in refractive index of the bulk solution or to the deposition of material on the surface, in the latter case the amount of material being deposited is proportional to the shift in resonance angle. To distinguish between the two possibilities, i.e. to eliminate the influence of the bulk refractive index, measurements were performed with the same supernatant before and after the deposition steps.

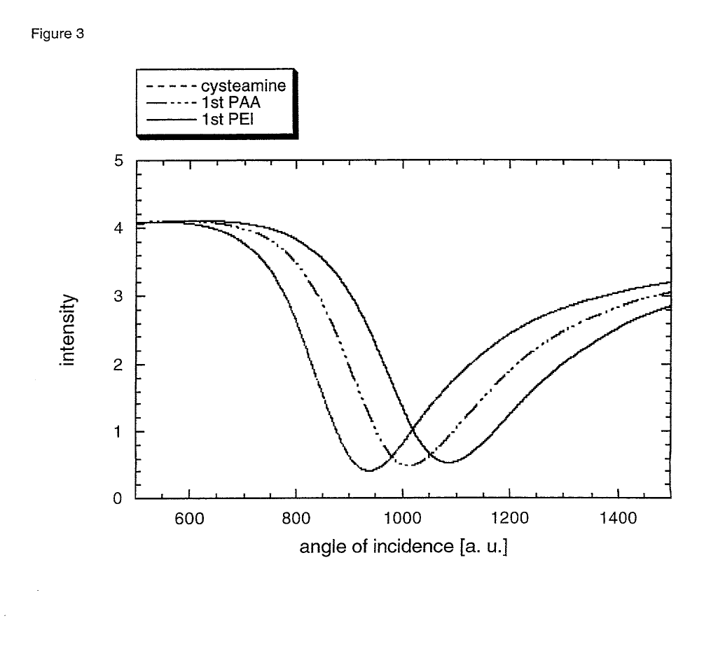

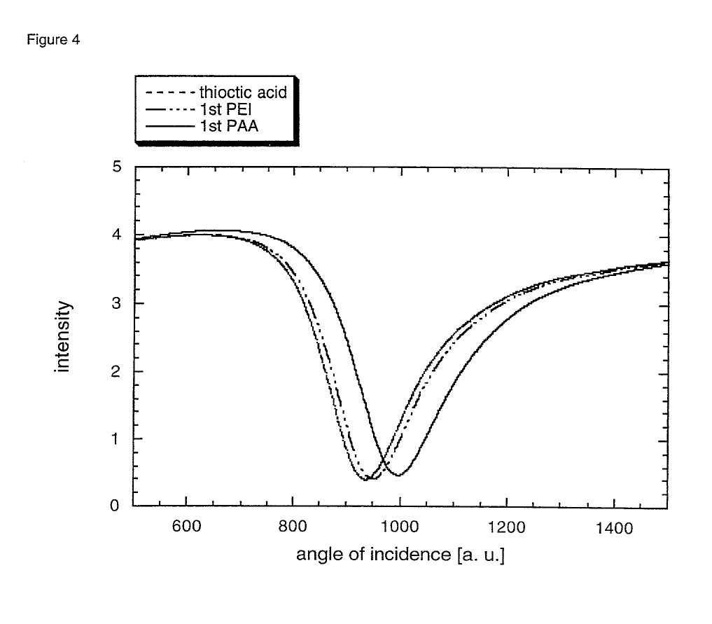

Assembly 1 shows a strong shift of about 80 units for the first deposition of poly(acrylic acid) (PAA), and of about 75 units for the first deposition of poly(ethyleneimine) (PEI) (FIG. 3). In contrast, the shift for the first deposition of PEI in assembly 2 is only 14 units (FIG. 4).

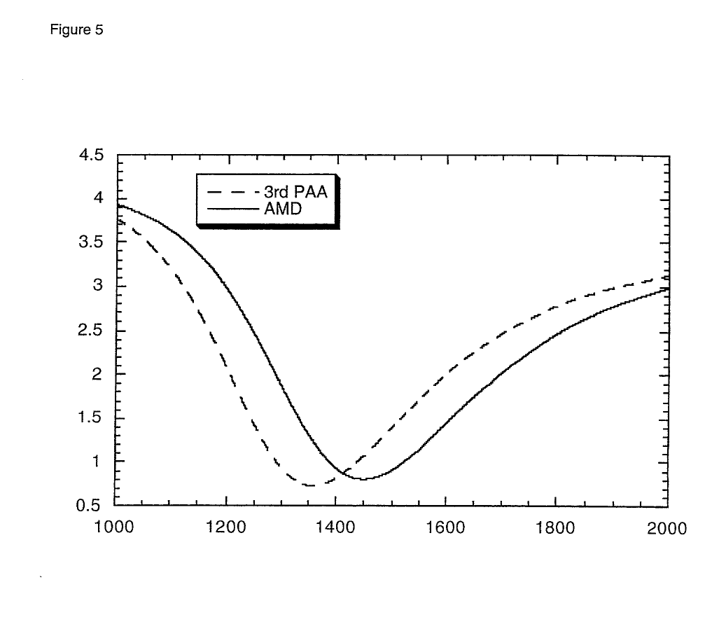

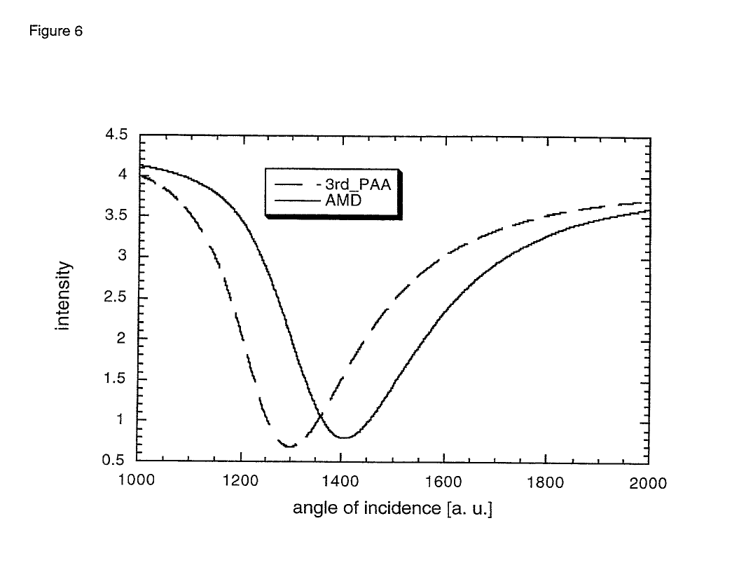

This difference may be caused by a lower density of functional groups on the modified gold surface: Cysteamine, a thiol with a very low molar mass used to start assembly 1 may react faster and more completely with the gold surface than thioctic acid, a somewhat heavier disulfide used for assembly 2. However, the significant differences in the assemblies are compensated with increasing number of polymer layers: for the aminodextran (AMD) layer, a shift of 90 units is found in assembly 1 (FIG. 5), and a shift of approx. 100 units in assembly 2 (FIG. 6). Very similar amounts of AMD are deposited on both assemblies.

This is a first proof for the efficiency of the multilayer concept.

Immobilisation of Biomolecules

To prove the validity of the concept for the immobilisation of biomolecules, streptavidin was immobilised on both assemblies (data not shown). Then, the binding of biotinylated protein A to streptavidin on both assemblies was measured in real time by plotting the resonce angle versus time.

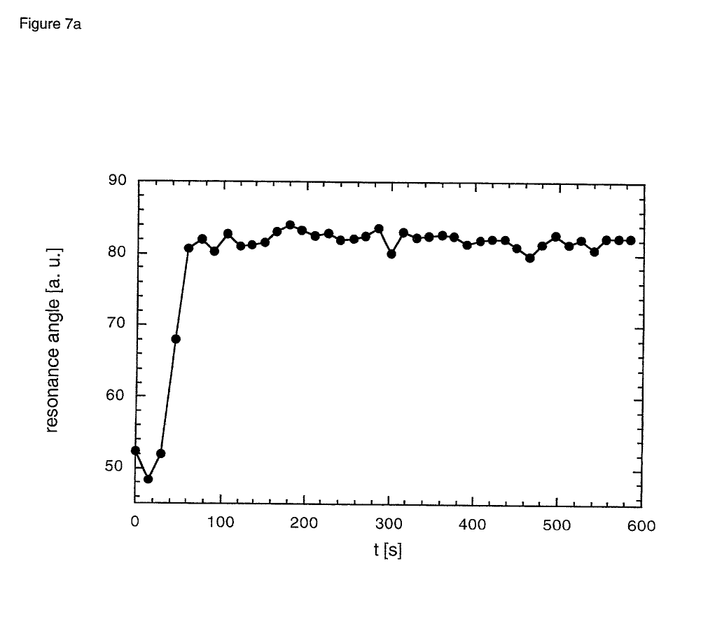

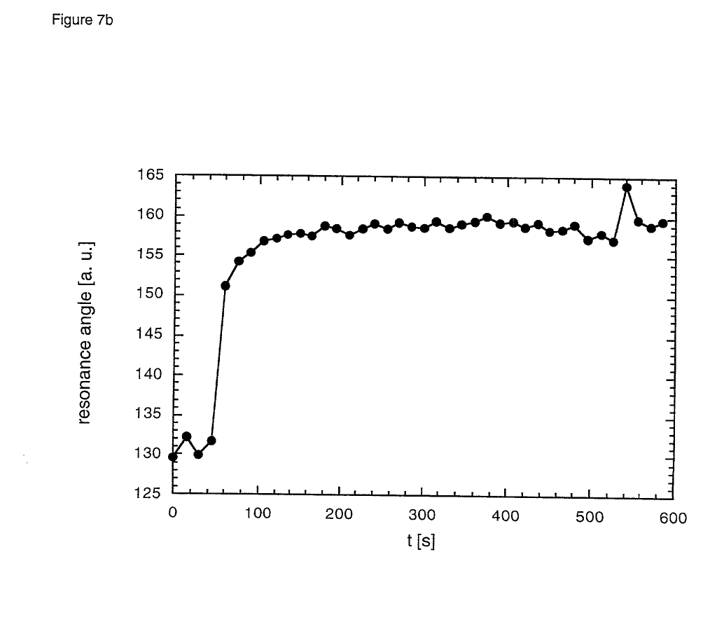

The result is shown in FIGS. 7a and 7b: On both assemblies, the amount of immobilised protein A, indicated by the shift in resonance angle, is very similar (approx. shift of 29 units for both assemblies) and the time needed to reach saturation does not exhibit important differences, either (approx. 150 seconds for each assembly).

In spite of the significantly different starting surfaces (i.e. the thiol/disulfide modified gold layers), both assemblies exhibit a very similar behaviour towards biomolecules as a consequence of the more complete shielding of the original surface by the polymer layers.

Prevention of Non-Specific Adsorption

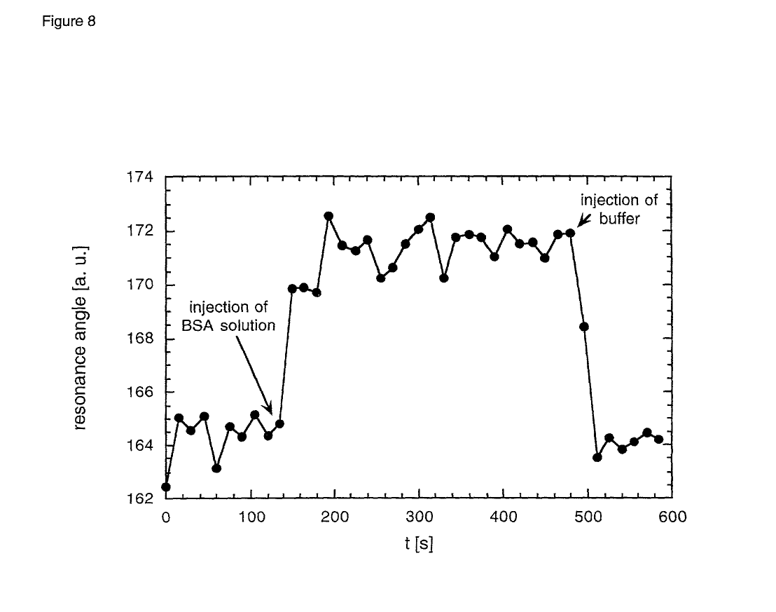

To test for non-specific adsorption, the hydrogel of multilayer assembly 2 was exposed to a 150 μg·ml⁻¹ solution of bovine serum albumine (BSA) in saline HEPES {2-[4-(2-Hydroxyethyl)-1-piperazino]-ethane-1-sulfonic acid} buffer. The BSA concentration exceeds the typical concentrations of analyte solutions for biomolecular interaction experiments by a factor of 3 to 10 and the solvent is frequently used for such experiments. The SPR signal was recorded before during and after the exposure. FIG. 8 shows the shift of the resonance angle, indicating the deposition of material, in dependence of time during the exposure.

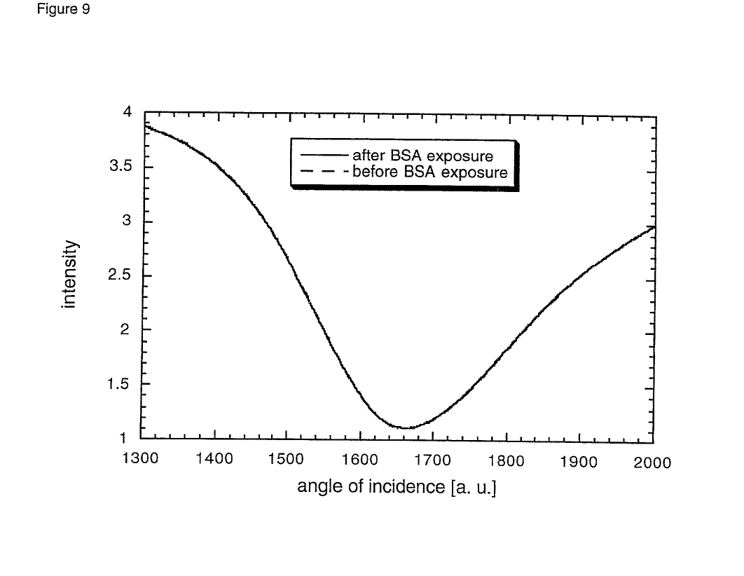

On injection of the BSA solution, the resonance angle increases, mainly due to the higher refractive index of the BSA solution compared to the pure buffer. Most important, no significant increase of the resonance angle during BSA exposure can be detected. The increase from 170 units at t=150 s (immediately after injection of BSA) to 172 units at t=481 s (just before injection of pure buffer) is within the noise of the SPR system. Moreover, as shown in FIG. 9, the resonance curves before and after BSA exposure, both recorded with the sample in saline HEPES buffer, do not show any difference within the limits of accuracy. This means only negligible non-specific adsorption of BSA to the hydrogel is detectable.

### EXAMPLE 3

General Remarks:

SPR measurements were performed with a home-built Θ/2Θ-setup according to Kretschmann & Raether (E. Kretschmann, H. Raether, Radiative Decay of Non-Radiative Surface Plasmons Excited by Light, Z. Naturforsch., vol. 23a, p. 2135 (1968));

concentrations of the polymers always refer to the repeat units;

H₂O is demineralised H₂O with a minimum resistivity of 5 MΩ;

in order to enable monitoring of the multilayer assembly by SPR, the gold surfaces are approx. 50 nm thick gold layers on a glass prism.

For the time-resolved measurements, the resonance angles were determined by intensity measurements at a fixed angle in real time.

Experimental Conditions:

Preparation of the Multilayer Assembly

(1) cleaning of gold surface by immersion in 0.1 M KOH/30 wt % H₂O₂ (50:50 vol.) for 20 minutes at 60° C.;

(2) immersion of cleaned gold surface in a solution of thioctic acid (2·10⁻² mol·1⁻¹) in water for 20 h at ambient temperature;

(3) rinsing with water for 1 minute;

(4) incubation with 23 mg of EDC and 13 mg of sulfo-NHS in 300 μl of water for 20 minutes;

(5) rinsing with water for 1 minute;

(6) incubation with 5 weight % poly(allylamine hydrochloride) in H2O for 20 minutes;

(7) rinsing with water for 1 minute;

(8) incubation with a mixture of 500 μl of a poly(acrylic acid) solution (2·10⁻² mol·1⁻¹), 10 mg EDC and 10 mg sulfo-NHS;

(9) rinsing with water for 1 minute;

(10) incubation with 5 weight % poly(allylamine hydrochloride) in H₂O for 20 minutes;

(11) rinsing with water for 1 minute;

(12) incubation with mixture of a 2 wt % solution of carboxy methyldextran in H₂O with 18 mg EDC and 18 mg sulfo-NHS for 20 minutes;

(13) rinsing with water three times for 1 minute.

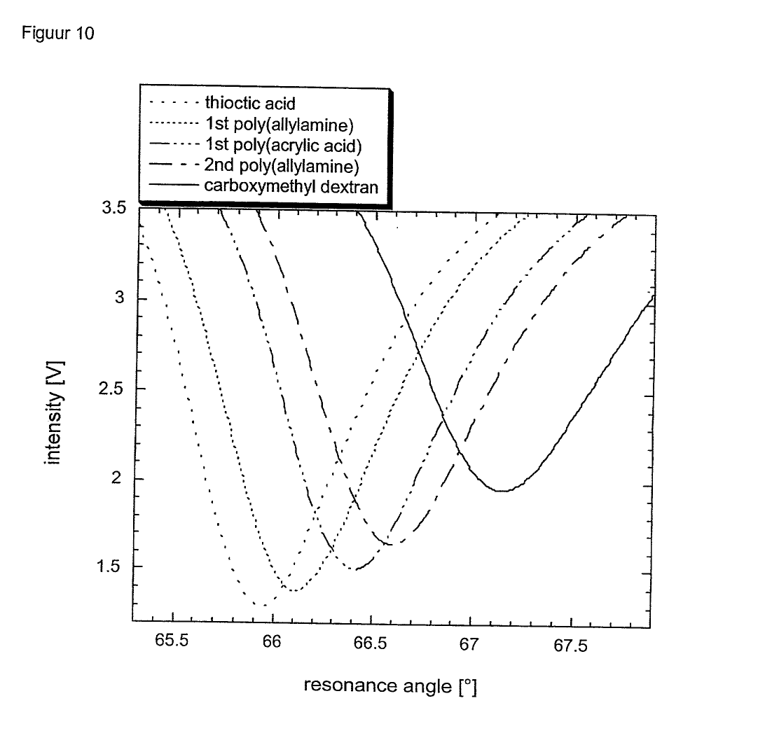

The results of surface plasmon resonance measurements made after the deposition of each layer are shown in FIG. 10.

Covalent Immobilisation of Protein A to the Multilayer Assembly

(protein A is a protein from staphylococcus aureus that specifically binds to the F_{c} parts of immunoglobulin G (IgG)).

(1) incubation with a solution of 11 mg of EDC and 76 mg of NHS in water for 10 minutes;

(2) incubation with a 100 μg/ml solution of protein A in saline sodium acetate buffer pH 4.7 for 20 minutes;

(3) rinsing with saline sodium acetate buffer pH 4.7 for 30 s;

(4) incubation with a solution of 0.98 g of ethanolamine in 10 ml of water pH 8.5 for 10 minutes;

(5) rinsing with saline sodium acetate buffer pH 4.7 for 1 minute.

Interaction Experiments, Incubation with Biologically Active Species

Bovine serum albumine (BSA) does not specifically interact with protein A and is used as a test substance to probe for non-specific adsorption. Immunoglobulin G (IgG) specifically binds to protein A (s. a.) and is used to prove the capability of the immobilised protein A to maintain its biological function.

(1) incubation with a solution of 3 μg/ml of IgG in HBS buffer pH 7.4 for 18 minutes;

(2) rinsing with HBS buffer pH 7.4 for 1 minute;

(3) rinsing with 0.05 mol·1⁻¹ HCl_{aq} for 2 minutes for regeneration; the specific interaction is broken up and the signal goes back to baseline;

(4) incubation with a solution of 4.0 mg/ml of BSA in HBS buffer pH 7.4 for 18 minutes;

(5) rinsing with HBS buffer pH 7.4 for 1 minute.

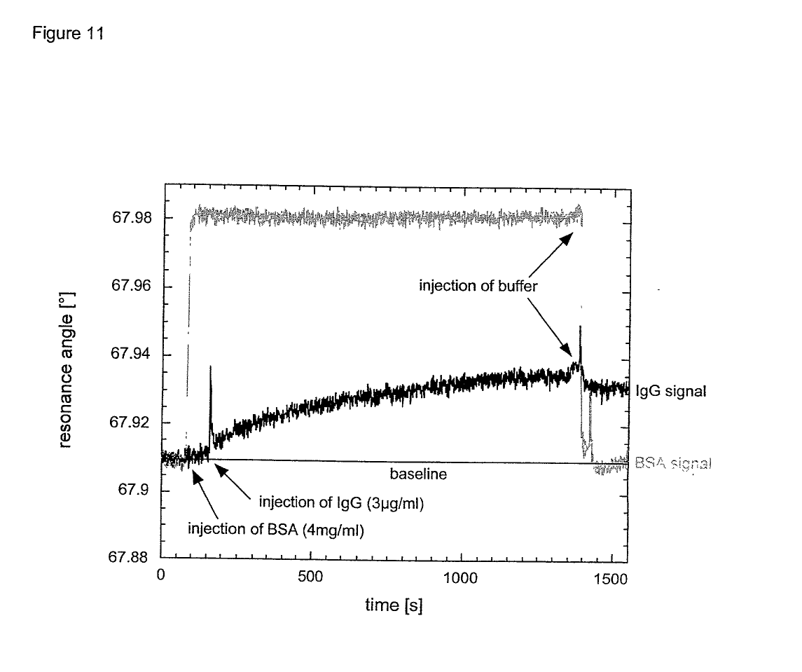

The results are shown in FIG. 11, which shows a comparison of incubations with IgG and BSA. For the reason of better comparability, the experiments which were performed after one another are plotted in the same time range. Within the limits of accuracy, no signal can be detected from BSA (the increase of the resonance angle during incubation is not caused by binding to the surface but by change of the bulk refractive index as a consequence of the high BSA concentration of 4 mg/ml). This indicates a very low non-specific adsorption. On the contrary, incubation with 3 μg/ml of IgG gives rise to an increase in resonance angle of 0.02° after rinsing with buffer, which indicates the specific binding of IgG to the immobilised protein A.

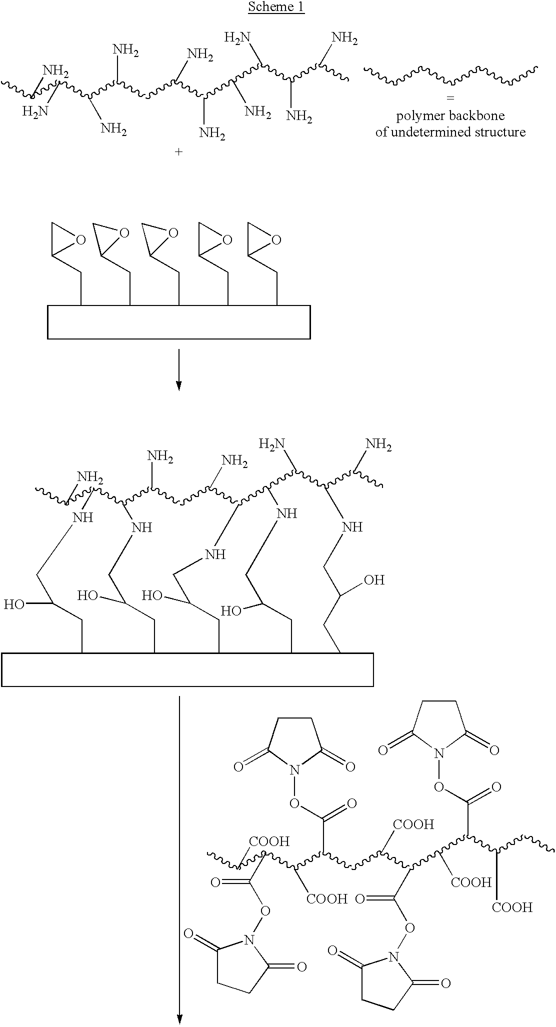

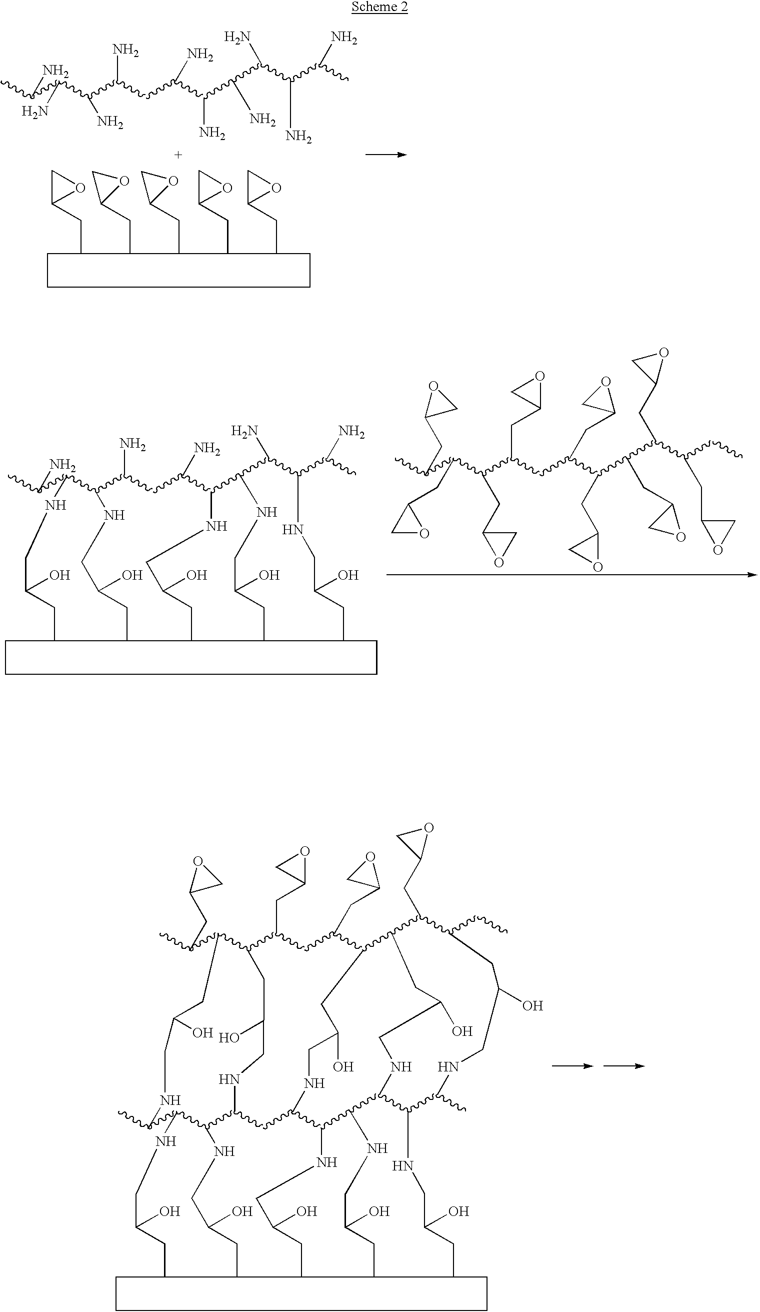

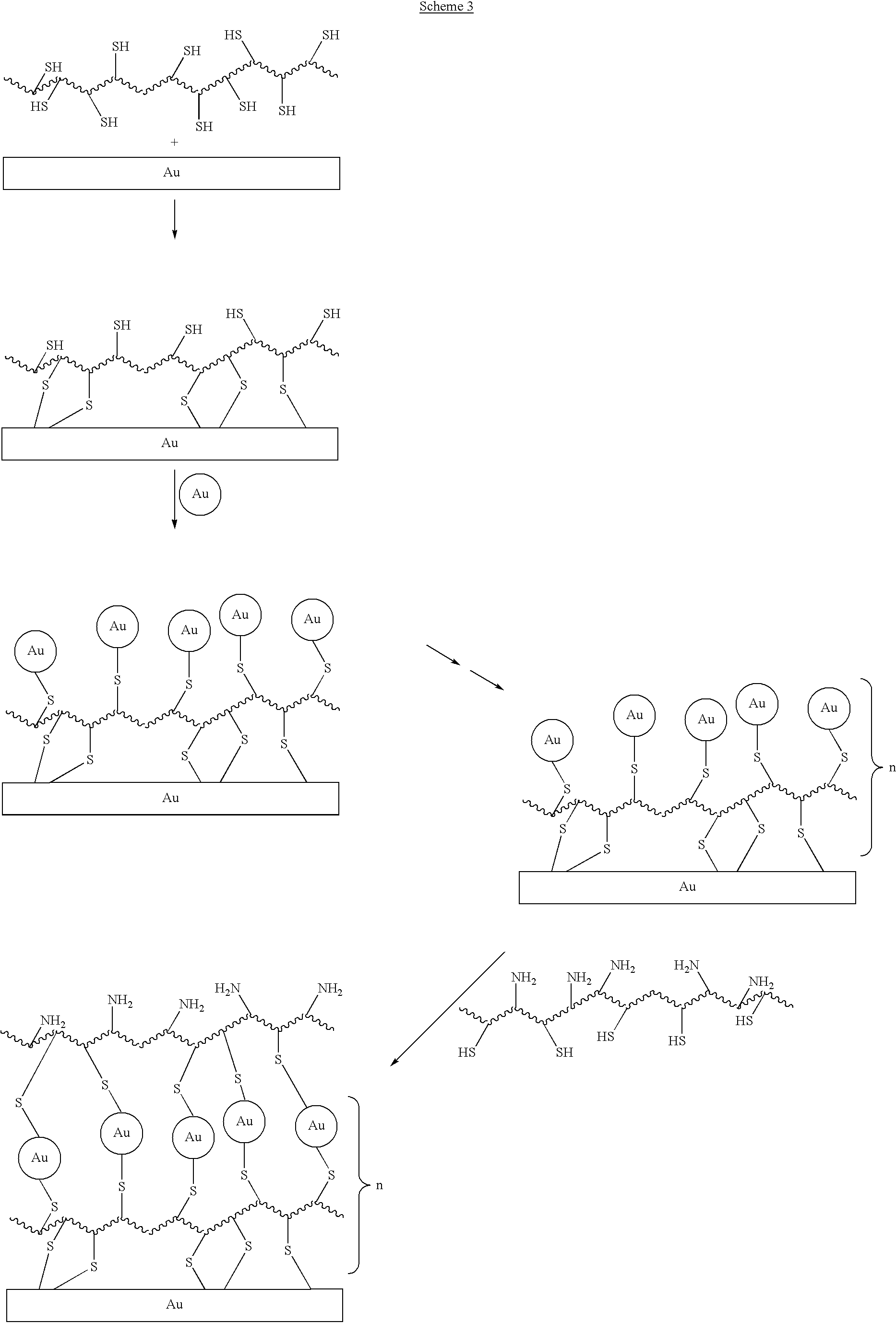

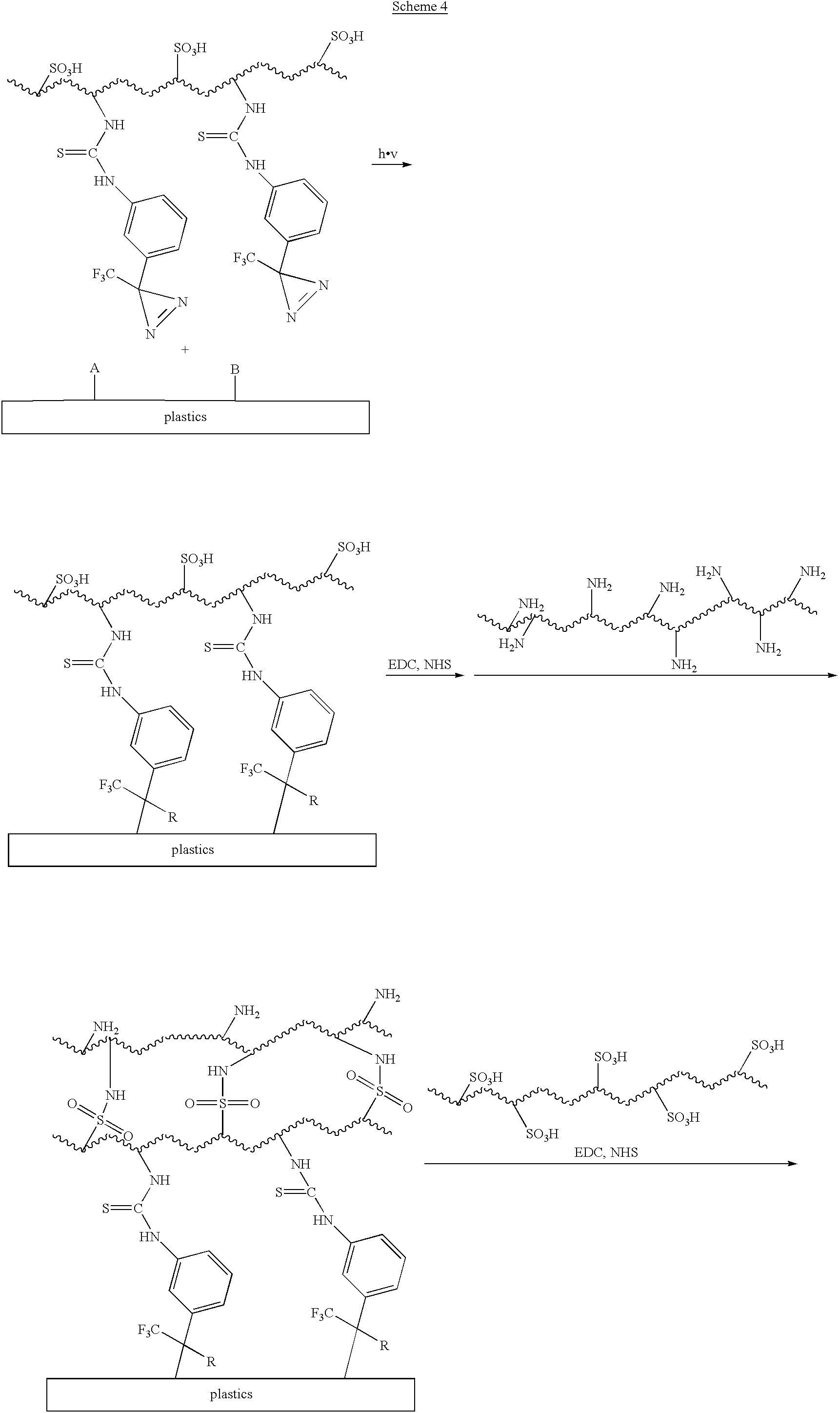

1. A product comprising a solid surface, a multilayer system of at least two covalently interconnected layers of a polymeric material covalently attached to said surface, and a biofunctional layer covalently attached to said multilayer system.

2. A product according to claim 1, wherein said multilayer system is attached to said surface layer via low molar mass linker molecules.

3. A product according to claim 1 or claim 2, wherein said biofunctional layer further comprises a bioactive ingredient.

4. A product according to any one of the previous claims, wherein said solid surface is selected from the group consisting of a metal, a metal oxide, a semiconductor, a semimetal oxide, a transitional element oxide, glass, silica, a plastic, and combinations thereof.

5. A product according to any one of the previous claims, wherein said solid surface is selected from the group consisting of a noble metal, glass, silica, a plastic, and combinations thereof.

6. A product according to any one of the previous claims, wherein said covalently interconnected layers are composed of organic polymers.

7. A product according to claim 6, wherein said multilayer system comprises covalently linked alternating layers of a first and a second polymer, which first and second polymer comprise functional moieties, which functional moieties are a pair selected from carboxylate/amine, sulfate/amine, sulfonate/amine, alcohol/epoxide, amine/carbonate residues, and thiol/disulfide; for the moieties on the first polymer/second polymer respectively.

8. A product according to claim 7, wherein said first polymer is chosen from the group consisting of poly(acrylic acid), poly(methacrylic acid), poly(styrene-4-carboxylic acid) and poly(glutamic acid); and said second polymer is chosen from the group consisting of poly(ethylenimine), poly(allylamine), poly(lysine) and poly(arginine).

9. A product according to any one of claims 1-5, wherein said covalently interconnected layers are composed of an organic polymer and a colloid.

10. A product according to claim 9, wherein said multilayer system comprises covalently linked alternating layers of a polymer with thiol groups and a metal colloid, in particular an Au colloid.

11. A product according to any one of claims 9-10, wherein the diameter of the colloid particles does not exceed 30 nm.

12. A product according to any one of the previous claims, wherein said biofunctional layer comprises low molar mass molecules covalently coupled to the outermost polymer layer.

13. A product according to any one of the previous claims, wherein said biofunctional layer comprises a hydrogel, preferably a hydrogel bearing biofunctional groups.

14. A product according to claim 13, wherein said hydrogel comprises a synthetic hydrophilic polymer, preferably selected from the group of poly(vinylalcohol), poly(hydroxyethylacrylate), poly(hydroxyethyl-methacrylate), poly[tris(hydroxymethyl)methylacrylamide], poly(ethylene oxide), poly(1-vinyl-2-pyrrolidon) and poly(dimethylacrylamide), or copolymers thereof.

15. A product according to any one of the previous claims, wherein said biofunctional layer is a hydrogel comprising a polysaccharide, preferably a polysaccharide selected from the group of dextran, pullulan, inulin and hydroxyethylcellulose.

16. A product according to any one of claims 13-15, wherein said hydrogel bears biofunctional groups that are carboxy groups and/or amino groups.

17. A product according to any one of the previous claims, comprising from 3 to 6 covalently interconnected polymer layers.

18. A product according to any one of the previous claims, wherein the individual polymer layers do not exceed a thickness of 20 nm.

19. A product according to any one of the previous claims, wherein the individual polymer layers do not exceed a thickness of 10 nm.

20. A product according to any one of the previous claims, which is selected from the group consisting of a biosensor, an implant, a sample container, affinity sensor arrays, affinity chromatography media, a device for solid phase diagnostics, a device for extra-corporeal therapy and a device for solid phase bio-organic synthesis.

21. A method for making a product having a solid surface coated with polymeric layers and a biofunctional layer, comprising the steps of
(a) functionalizing said surface;
(b) covalently coupling a polymer layer with one type of functional group to said surface;
(c) covalently coupling a polymer layer with a second type of functional groups to the previous polymer layer, optionally after having activated the functional groups of said previous polymer layer with a suitable activating reagent;
(d) optionally repeating steps (b) and (c); and
(e) covalently coupling a biofunctional layer which is suitable for the binding of bioactive molecules and/or the prevention of non-specific adsorption, to the assembly.

22. A method according to claim 21, wherein the polymer of the first polymer layer is a polyamine, the polymer of the second polymer layer is a polycarboxylate, and the biofunctional layer is a hydrogel layer.

23. A method according to claim 22, wherein the polyamine is selected from the group consisting of poly(ethyleneimine), poly(allylamine), poly(lysine) and poly(arginine).

24. A method according to claim 22, wherein the polycarboxylate is selected from the group consisting of poly(acrylic acid), poly(methacrylic acid), poly(styrene-4-carboxylic acid) and poly(glutamic acid).

25. A method according to claim 22, wherein the hydrogel comprises a polysaccharide selected from the group consisting of dextran, pullulan, inulin, hydroxyethylcellulose and their carboxymethyl derivatives.

26. A method according to claim 22, wherein the hydrogel comprises a synthetic hydrophilic polymer, preferably selected from the group of poly(vinylalcohol), poly(hydroxyethylacrylate), poly(hydroxyethyl-methacrylate), poly[tris(hydroxymethyl)methylacrylamide], poly(ethylene oxide), poly(1-vinyl-2-pyrrolidon) and poly(dimethylacrylamide), or copolymers thereof.
